(19) United States
(12) Patent Application Publication
(10) Pub. No.: US 2025/0015306 A1
(43) Pub. Date: Jan. 9, 2025

(54) METHOD FOR PRODUCING A LEAD-CONTAINING PLATE FOR A BATTERY HAVING AT LEAST ONE PROJECTION

(71) Applicant: H. Folke Sandelin AB, Motala (SE)

(72) Inventors: Joachim SEITZ, Oberasbach (DE); Rolf BRAUN, Duisburg (DE)

(21) Appl. No.: 18/763,785

(22) Filed: Jul. 3, 2024

(30) Foreign Application Priority Data
Jul. 5, 2023 (DE) 10 2023 206 381.6

(51) Int. Cl. H01M 4/82; B21D 22/20; H01M 4/02; H01M 4/73; H01M 10/14; H01M 10/18

(52) U.S. Cl. CPC H01M 4/82; B21D 22/20; H01M 4/73; H01M 10/14; H01M 10/18; H01M 2004/029

(57) ABSTRACT

A method for producing a leaded plate for a battery which has at least one projection comprising the steps:
a) providing a leaded workpiece,
b) providing a tool having a lower die and an upper die, wherein the lower die and/or the upper die have at least one recess,
c) arranging the workpiece between the lower die and the upper die,
d) arranging a deformable intermediate plate between the workpiece and the upper die or lower die,
e) arranging a first strip and at least one second strip between the intermediate plate and the upper die or the lower die on a side of the intermediate plate facing away from the workpiece,
f) executing a relative motion between the upper die and the lower die along a first direction which reduces a distance between the upper die and the lower die in order to exert pressure on the workpiece via the intermediate plate, the first strip and the at least one second strip and thereby effect a flowing movement of the material of the workpiece in a second direction running perpendicular to the first direction, wherein
   the first strip and the at least one second strip are arranged spaced at a distance from one another along the second direction in step e), and
   steps e) and f) are repeated multiple times so as to effect at least a portion of the material of the workpiece flowing into the at least one recess in order to form the at least one projection.

This application claims priority to DE 10 2023 206 381.6 filed Jul. 5, 2023, the entire contents of which are hereby incorporated by reference.

The present invention relates to a method for producing a leaded plate for a battery which has at least one projection. The present invention further relates to a method for producing a bipolar plate for the battery utilizing the leaded plate having the at least one projection, a method for producing the battery as well as the battery.

The present invention relates in particular to a method for producing a leaded plate or film for a battery, in particular a bipolar lead-acid battery, which has at least one projection in which the height of the at least one projection is about two to five times greater than the thickness of the leaded plate between projections.

Bipolar lead-acid batteries are generally known, e.g. from U.S. Pat. No. 8,357,469 B2 and U.S. Pat. No. 9,634,319 B2.

In one known in-house method for producing a plate with projections, a workpiece is formed using a press tool having recesses such that part of the workpiece flows into the recesses to form the projections.

In order to form solid projections of a height about two up to five times greater than the plate thickness between the projections with this method, the workpiece needs to be of comparatively high starting material thickness. This leads to a correspondingly large compression path and displaced workpiece volume.

When the workpiece is compressively stressed by the press tool and the yield limit of the workpiece exceeded, the workpiece will begin to flow plastically. A preferably rectangular-shaped workpiece under pressure from rigid plate-shaped parts of the press tool will flow in the direction of its length and width while its height is reduced. Accordingly, the surface area under pressure increases as does the force required to maintain the plastic flow. As the surface area increases, more and more material comes into contact with a mostly full-surface active part of the press tool. This leads to an increase in frictional force, which acts counter to the increase in surface area, whereby there is a sharp increase in the forming force needed to be applied and presses able to apply higher pressure as well as press tools of increased mechanical stability, particularly as regards their press plates, become necessary. The high contact stresses lead to the elastic embedding of the formed workpiece in the tool, which can result in difficulties as regards adherence to thickness tolerances and/or forming solid projections on the produced workpiece.

One task of the present invention is that of providing an improved method for producing a leaded plate or film for a battery which has at least one projection. Further tasks of the present invention are providing an improved method for producing a bipolar plate for the battery, an improved method for producing the battery, as well as providing an improved battery.

These tasks are solved by the features of the independent claims. Further preferential embodiments of the invention constitute the subject matter of the dependent claims.

According to a preferential embodiment, a method for producing a leaded (lead-containing) plate or film for a battery which has at least one projection comprises the steps of:
a) providing a leaded (lead-containing) workpiece,
b) providing a tool having a lower die and an upper die, wherein the lower die and/or the upper die have at least one recess,
c) arranging the workpiece between the lower die and the upper die,
d) arranging a deformable intermediate plate, in an embodiment a planar deformable intermediate plate, between the workpiece and the upper die or lower die,
e) arranging a first strip and at least one second strip between the intermediate plate and the upper die or the lower die on a side of the intermediate plate facing away from the workpiece,
f) executing a relative motion between the upper die and the lower die along a first direction which reduces a distance between the upper die and the lower die in order to exert pressure on the workpiece via the intermediate plate, the first strip and the at least one second strip and thereby effect a flowing movement of the material of the workpiece in a second direction running perpendicular to the first direction, wherein
   the first strip and the at least one second strip are arranged spaced at a distance from one another along the second direction in step e), and
   steps e) and f) are repeated multiple times so as to effect at least a portion of the material of the workpiece flowing into the at least one recess in order to form the at least one projection.

To be understood by “a leaded plate having at least one projection” is in particular a lead-containing material geometrically formed by two main faces faced away from each other and lateral faces connecting the two main faces, wherein the main faces are preferably flat/planar or substantially flat/planar, and the at least one projection extends from one of the main faces in a direction away from said main face, preferably perpendicular with respect to said main face. Particularly the surface area of the main face is thereby larger than the lateral faces. Furthermore, particularly a thickness of the leaded plate having the at least one projection, being a distance of the two main faces measured along a direction perpendicular to at least one of the two main faces, is thereby substantially smaller than a length and/or width of the leaded plate having at least one projection. Preferably, the thickness of the leaded plate having the at least one projection is substantially constant.

To be understood by a “workpiece” is in particular a semifinished product, a blank or the like which is preferably produced by providing and subsequently machining a starting material such that the “workpiece” provided in step a) and arranged between the lower die and the upper die in step c) exhibits a predefined shape. Upon executing step f) at least once, the “workpiece” is machined via the interaction of areas of the upper or lower dies on which the first or respectively second strip rests, the first/second strips, the intermediate plate and areas of the other of the upper and lower die on which the “workpiece” rests so as to form at least part of the workpiece or a portion of the workpiece material respectively.

To thereby be understood in one preferential embodiment by a first or second strip is an elongate object made from a material geometrically shaped with two main faces faced away from each other and lateral faces connecting the two main faces, wherein preferably at least upon a final implementation of steps e) and f), the main face facing toward the intermediate plate is planar or flat or substantially planar/flat.

To be understood by a “deformable intermediate plate” is an object made from a material geometrically shaped with two main faces faced away from each other and lateral faces connecting the two main faces, wherein the “deformable intermediate plate” is in particular elastically deformable and the material of the “deformable intermediate plate” exhibits significantly higher strength simultaneously coupled with lower rigidity than the first or second strip.

In one preferential embodiment, utilizing the first strip, the at least one second strip and the intermediate plate enables deliberately keeping the surface area of the workpiece under direct pressure and the workpiece volume involved in the forming process small. Doing so enables keeping the pressure needed to be applied by the tool, in particular press tool, low and ensures adherence to strict thickness tolerances.

One substantial component for ensuring that the at least one projection can be solidly formed is thereby the intermediate plate which transmits the force of the first strip or respectively center strip, preferentially arranged in a center of the workpiece relative to the second direction, and the at least one second strip or respectively lateral strip, preferentially two second strips, to the material to be deformed.

On the one hand, the intermediate plate prevents the material of the workpiece from potentially rising up or sinking into gaps between various components of the upper die or lower die.

On the other hand, the elastic pliability of the intermediate plate is of importance. The positive impact on the planarity of the leaded plate produced results from the initial yieldability of the intermediate plate, whereby the already thin material of the workpiece is put under tensile stress after the initial motion or the first partial execution of step f) respectively. Upon the further lowering of the upper die and/or the increasing height of the lower die within the scope of the relative motion, the center, braced by the first strip, or center strip respectively, engages.

Due to the effective state of tensile stress, the displaced material of the workpiece has a strong tendency to flow outward along the second direction. Return flow to the center is prevented by the coordinated displacement action of the first strip, or center strip respectively, and the counterpressure applied by the at least one second strip, or lateral strip respectively, as is necessary for the complete filling of the at least one recess.

The forming of a solid projection by gradually filling the at least one recess is thereby achieved by means of the lateral flow of the workpiece material along the second direction.

The material of the workpiece displaced into the center by the first strip/center strip is put under pressure by the at least one second strip/lateral strip. This state of pressure prevents the material of the workpiece from flowing off beyond the at least one recess without resistance. The lateral pressure encourages the workpiece material to flow into the at least one recess. Also helpful here is the early building of accumulations of the workpiece material (mounds) between the first strip and the at least one second strip. The height of these workpiece material accumulations exceeds the thickness of the workpiece's starting material. These accumulations of workpiece material are formed under the elastically bent intermediate plate. The material volume in the mounds is influenced by the position of the at least one second strip/lateral strip and the lateral boundary effected by the first strip/center strip. The thickness of the intermediate plate is also a not insignificant parameter as its elastic curve is directly dependent on the flexural rigidity.

The leaded workpiece provided in step a) can be a pure lead material with a lead content of 100% or nearly 100%. However, the provided leaded workpiece can also be a lead alloy containing an additional material besides lead. The additional material is preferably able to reduce the forming or thickness of a passivation layer as commonly occurs with pure lead material and/or increase the strength of the workpiece and/or reduce corrosion of the workpiece. The additional material can thereby preferably contain calcium and/or zinc and/or silver and/or tin and/or another appropriate metal. Preferentially, the leaded workpiece is a lead-tin alloy having for example a tin content of 0.8% to 1.5%, preferably a tin content of 1.4%, which in an embodiment additionally contains calcium at a calcium content of e.g. 0.05% to 0.1%, preferably a calcium content of 0.08%, and/or can contain other metals such as silver or antimony.

The leaded workpiece provided is preferentially a cohesive material such as a lead-based (lead-containing) plate. The leaded workpiece provided as a lead-based plate is preferably cube-shaped or rectangular and/or can in some realizations exhibit the approximate dimensions of 0.5-1.1 mm×70-150 mm×70-500 mm; in one realization 0.9 mm×70-75 mm×175-180 mm. According to an embodiment, the workpiece designed as a leaded plate is produced by means of casting and/or milling and, if needed, reannealing.

In one preferential embodiment, steps e) and f) are performed at least 5 times, preferentially at least 10 times, particularly preferentially at least 18 times.

The method according to the invention preferentially produces a preferably cube-shaped or rectangular leaded plate for a battery which has at least one projection. In some realizations, the dimensions of the leaded plate having at least one projection produced by means of the inventive method can amount to approximately 0.05-0.35 mm×130-500 mm×130-500 mm. In some implementations, a height of the at least one projection of the leaded plate having at least one projection produced by the inventive method can be in a range of from 0.4 mm to 1.5 mm, preferentially a range of from 1.0 mm to 1.2 mm, and can particularly preferentially be 1.1 mm. A plurality of recesses can thereby be provided or arranged, for example in multiple rows and columns, e.g. six recesses, in particular in two rows and three columns, which in some implementations are of hollow cylindrical design having a diameter in a range of from approximately 7-25 mm, preferably a diameter of approximately 8-10 mm, in order to form a plurality of corresponding projections, particularly six corresponding projections.

According to a preferential embodiment, upon at least one repetition of step e), a first strip is arranged which has a larger width, measured along the second direction, than a width of a first strip arranged in a previous execution of step e).

According to a preferential embodiment, upon at least one repetition of step e), at least one of the at least one second strips is arranged in a different position relative to the second direction, in particular farther away from the first strip, as in a previous execution of step e).

According to a preferential embodiment, the workpiece is arranged in step c) so as to not overlap the at least one recess along the first direction.

Preferentially, a first strip and two second strips are arranged in such a manner in step e) that the first strip is arranged between the two second strips and the two second strips are arranged such that in the immediately following step f), the flowing movement of the workpiece material in the second direction is at least limited by a deformation of the intermediate plate effected by the two second strips.

The first strip and the two second strips can thereby be preferentially arranged parallel to each other in step e), and the first strip arranged in the center between the two second strips, whereby a distance between the two second strips, measured along the second direction, is greater upon at least one repetition of step e) than in a previous execution of step e).

Preferentially, the two second strips are arranged symmetrically with respect to the first strip in step e).

According to a preferential embodiment, a position of the first strip and/or the at least one second strip is fixed in the second direction by means of a retaining device or the first strip and/or the at least one second strip is affixed to the intermediate plate.

According to a preferential embodiment, the intermediate plate is deformed upon at least one execution of step f), wherein after step f) is executed, a thickness of the material of the workpiece is greater at a position arranged between the first strip and at least one of the at least one second strips than at a position at which the first strip overlaps the workpiece along the first direction and/or is greater than at a position at which the at least one second strip overlaps the workpiece along the first direction.

Preferentially, a tool with a device is provided in step b) which is configured to limit flowing movement of the workpiece material during step f) in a third direction running perpendicular to the first direction and perpendicular to the second direction, limiting it on both sides in one preferential embodiment, in order to obtain a leaded plate of a predetermined length for a battery which has at least one projection. Preferably, this device is further configured to limit the flowing movement of the workpiece material during step f) in the second direction, in one preferential embodiment limit it on both sides. This thereby allows selecting a length of the first or respectively second strip along the third direction so as to correspond to the limiting of the flowing movement of the workpiece material which the device effects in the third direction. Furthermore, a length and width of the intermediate plate can be selected so as to correspond to the limiting of the flowing movement of the workpiece material in the second or third direction as effected by the device.

In a particularly preferential embodiment, step a) comprises an extruding of a leaded material in order to obtain a leaded workpiece formed as a leaded extrudate, wherein the leaded extrudate is arranged between the lower die and the upper die in step c).

The extrusion enables a leaded extrudate to be produced or respectively provided as the workpiece which is more pliable, or exhibits greater elasticity respectively, than a corresponding leaded plate produced by casting and/or milling. This thereby advantageously enables forgoing reannealing of the extrusion-produced workpiece as a leaded extrudate as is necessary in the case of leaded plates produced by casting and/or milling, in order to obtain the material properties required for subsequent method steps as regards deformability. In addition, the workpiece produced by extrusion and formed as a leaded extrudate advantageously exhibits smaller particle sizes than the corresponding workpiece produced via milling and/or casting and/or reannealing.

According to a preferential embodiment, particle size of the material of the leaded plate for the battery having at least one projection is in a range of from 10 μm to 40 μm.

According to a preferential embodiment, at least once prior to the repeated execution of steps e) and f), another deformable intermediate plate is arranged between the workpiece and the upper die or the lower die in step d) than in the previously executed steps e) and f). The other deformable intermediate plate can thereby in particular be designed so as to be differently deformable than the intermediate plate utilized in the previously executed steps e) and f).

According to a preferential embodiment, the at least one recess is completely filled with a portion of the material of the workpiece after a final repetition of steps e) and f) has been executed.

According to a preferential implementation, after a final repetition of steps e) and f) has been executed, a length and/or width of the workpiece machined by means of the method is shortened to a predetermined length and/or a predetermined width, particularly using a punch tool, in order to obtain a leaded plate of a predetermined length and/or predetermined width for a battery which has at least one projection.

According to a preferential implementation, a leaded workpiece is provided in step a) which has a profile with a thickness measured in or along the first direction, in particular after the workpiece is arranged between the lower die and the upper die in step c), which varies along the second direction in a cross section along a plane spanned by the first direction and the second direction.

In a case in which the leaded workpiece is produced or provided in step a) by means of an extrusion process, the corresponding design to the leaded workpiece can be achieved by utilizing a (counter) die shaped in conformity with the desired profile, and in a case in which the leaded workpiece is produced or provided in step a) via a milling process, by making use of a longitudinal rolling process executed in conformity with the profile desired.

According to a preferential implementation, a leaded workpiece with a profile is provided in step a), the thickness of which is greater in two areas arranged substantially symmetrically about a center of the leaded workpiece arranged with respect to the second direction than in other areas. The difference in thickness between the two areas arranged substantially symmetrically about a center of the leaded workpiece arranged with respect to the second direction and the other areas can thereby amount to e.g. 0.3 mm to 2 mm.

In an implementation, this can thereby achieve a reduction in the number of forming steps required or the required number of repetitions of steps e) and f) respectively. Alternatively or additionally, the force to be exerted by the press in the forming of the leaded workpiece can thereby be reduced, whereby a more economical and/or more lightweight press can be used in executing the inventive method.

A method according to a preferential embodiment for producing a bipolar plate for a battery, particularly a bipolar battery, e.g. a bipolar lead-acid battery, comprises in particular:
providing a substrate with at least one opening, in particular a passage opening,
providing a leaded plate having at least one projection produced by means of an above-described method for producing a leaded plate or film for a battery having at least one projection,
providing a further leaded plate having at least one projection produced by means of an above-described method for producing a leaded plate or film for a battery having at least one projection or providing a substantially planar leaded plate or film, and
arranging the leaded plate having the at least one projection on a main face of the substrate such that the at least one projection extends into the at least one opening of the substrate, arranging the further leaded plate having the at least one projection on another main face of the substrate such that the at least one projection extends into the at least one opening of the substrate, and establishing an electrically conductive connection between one end of the at least one projection of the leaded plate having the at least one projection and one end of the at least one projection of the further leaded plate having the at least one projection, wherein the end of the at least one projection of the leaded plate having the at least one projection and the end of the at least one projection of the further leaded plate having the at least one projection face each other, and applying a first active material onto a main face, which faces away from the substrate, of the further leaded plate having the at least one projection and applying a second active material onto a main face, which faces away from the substrate, of the leaded plate having the at least one projection, or
arranging the leaded plate having the at least one projection on a main face of the substrate such that the at least one projection extends through the at least one opening of the substrate, arranging the substantially planar leaded plate on another main face of the substrate, and establishing an electrically conductive connection between one end of the at least one projection of the leaded plate having the at least one projection facing the substantially planar leaded plate and the substantially planar leaded plate, and applying a first active material onto a main face, which faces away from the substrate, of the substantially planar leaded plate and applying a second active material onto a main face, which faces away from the substrate, of the leaded plate having the at least one projection.

A respective adhesive layer can thereby be applied or arranged between the main face of the substrate and the leaded plate having the at least one projection and/or between the other main face of the substrate and the further leaded plate having the at least one projection in order to fix the leaded plate having the at least one projection and/or the further leaded plate having the at least one projection to the substrate, or a respective adhesive layer can be applied or arranged between the main face of the substrate and the leaded plate having the at least one projection and/or between the other main face of the substrate and the substantially planar leaded plate in order to fix the leaded plate having the at least one projection and/or the substantially planar leaded plate to the substrate.

In an embodiment, the first active material is a positive active material, respectively a cathode material, and the second active material is a negative active material, respectively an anode material, while in another embodiment, the first active material is a negative active material, respectively an anode material, and the second active material is a positive active material, respectively a cathode material.

The substantially planar leaded plate or film can in particular be of or made from the same or substantially the same material as the workpiece, or the leaded plate having the at least one projection respectively, and apart from the projections, can exhibit the same or substantially the same dimensions as the leaded plate having the at least one projection.

Furthermore, the substantially planar leaded plate or film can be produced by means of an extrusion process using an extrusion apparatus such as a (counter) die shaped in conformity with the substantially planar profile of the substantially planar leaded plate or by means of a milling and/or casting process and/or reannealing.

In the case of the further leaded plate having the at least one projection being utilized in the method, the height of the at least one projection of the leaded plate having the at least one projection and the height of the at least one projection of the further leaded plate having the at least one projection is preferentially selected so as to equal or substantially equal half the thickness of the substrate or, when one or two adhesive layer(s) is/are applied to fix the leaded plate having the at least one projection and/or the further leaded plate having the at least one projection to the substrate, to equal or substantially equal half the sum total of the thicknesses of the substrate and adhesive layer(s). In another embodiment, the height of the at least one projection of the leaded plate having the at least one projection and the height of the at least one projection of the further leaded plate having the at least one projection can in this case be selected such that the sum of the two heights equals or substantially equals the thickness of the substrate or, when one or two adhesive layer(s) is/are applied to fix the leaded plate having the at least one projection and/or the further leaded plate having the at least one projection to the substrate, to equal or substantially equal the sum total of the thicknesses of the substrate and adhesive layer(s).

In the case of the substantially planar leaded plate being utilized in the method, the height of the at least one projection of the leaded plate having the at least one projection is preferentially selected so as to equal or substantially equal the thickness of the substrate or, when one or two adhesive layer(s) is/are applied to fix the leaded plate having the at least one projection and/or the substantially planar leaded plate to the substrate, to equal or substantially equal the sum total of the thicknesses of the substrate and adhesive layer(s).

In an embodiment, the substrate can be formed from, for example, an electrically insulating material such as plastic or can comprise or consist of same. In an embodiment, the substrate can comprise an electrically insulating material forming or at least substantially forming an outer form of the substrate and in which electrically conductive elements such as electrically conductive particles, electrically conductive fibers and/or a conductive powder are provided in a preferably homogeneous distribution.

An appropriate connection technique, preferably welding, in particular resistance welding, or soldering, can be used to establish the electrically conductive connection between the end of the at least one projection of the leaded plate having the at least one projection and the end of the at least one projection of the further leaded plate having the at least one projection or to establish the electrically conductive connection between the end of the at least one projection of the leaded plate having the at least one projection facing the substantially planar leaded plate and the substantially planar leaded plate.

Application of the first and/or second active material, in particular so as to form a layer of first or second active material, can for example comprise coating the respective main face with a paste comprising the first or second active material and a subsequent thermal treatment.

According to a preferential embodiment, the method for producing a bipolar plate for a battery further comprises:
providing a frame, and
arranging the frame such that the frame laterally surrounds the substrate, the leaded plate having the at least one projection, the further leaded plate having the at least one projection or the substantially planar leaded plate, the first active material and the second active material in the finished bipolar plate such that the frame laterally limits a free space above exposed surfaces of the first and second active material.

The frame, which is for example rectangular, is preferably formed from an electrically insulating material and serves in particular as housing for the remaining components of the bipolar plate.

The thicknesses and arrangements of the substrate, the leaded plate having the at least one projection, the further leaded plate having the at least one projection or the substantially planar leaded plate respectively, the first active material and the second active material are preferentially selected such that a total thickness of the arrangement is less than a thickness of the frame and in particular selected such that the free space above exposed surfaces of the first and second active material is laterally limited by the frame.

According to a preferential embodiment of the method for producing a bipolar plate for a battery, providing the frame comprises providing a frame formed integrally with the substrate or providing the frame comprises providing a frame having an internal groove, whereby a lateral section of the substrate is inserted into the groove.

A method according to a preferential embodiment for producing a battery, particularly a bipolar battery, for example a bipolar lead-acid battery, comprises:
stacking multiple bipolar plates produced by means of an above-described method for producing a bipolar plate atop one another such that the respective first active materials of the individual bipolar plates point in the same direction in order to form a stack of bipolar plates, wherein a respective electrolyte is arranged between a respective pair of adjacent bipolar plates, in particular between the facing first and second active materials of the adjacent bipolar plates, such that the respective electrolyte is both in contact with the first active material of one bipolar plate of the pair of bipolar plates as well as in contact with the second active material of the other bipolar plate of the pair of bipolar plates, and
establishing an electrically conductive connection between the first active material arranged on the main face, which faces away from the stack of bipolar plates, of a first bipolar plate of the stack of bipolar plates and a first terminal post of the battery, as well as establishing an electrically conductive connection between the second active material arranged on the main face, which faces away from the stack of bipolar plates, of a last bipolar plate of the stack of bipolar plates and a second terminal post of the battery.

Multiple bipolar plates, each preferably with a respective frame, are thereby preferentially stacked atop one another so as to form a stack of bipolar plates.

A respective spacer frame can be provided or arranged between the respective frames of adjacent bipolar plates which separates the respective frames of the adjacent bipolar plates and is or can be preferentially connected to the two frames of the adjacent bipolar plates such that a space is formed between the two adjacent bipolar plates, in particular between the facing first and second active materials of the adjacent bipolar plates, which in particular is sealed in fluid-tight manner and in which the respective electrolyte is or can be accommodated or introduced or arranged.

A respective end plate can be provided or arranged at a respective end of the bipolar plate stack, wherein a respective spacer frame can be provided or arranged between a surrounding projection or surrounding frame of a respective end plate and the frame of the respective adjacent bipolar plate which separates the respective frame of the respective bipolar plate and the surrounding projection or surrounding frame of the respective end plate, and is preferentially connected to the respective frame of the respective bipolar plate and the surrounding projection or surrounding frame of the respective end plate such that a space is formed between the respective end plate and the respective adjacent bipolar plate which in particular is sealed in fluid-tight manner.

A respective positive or negative end plate active material (end plate cathode material/end plate anode material) associated with the respective end plate can be provided on or applied to a side of a respective end plate facing a respective adjacent bipolar plate, wherein a respective connecting plate can be arranged between the respective end plate and the respective end plate active material which can in particular be electrically connected conductively to the respective end plate active material and a respective first or second terminal post of the battery (plus/minus terminal post of the battery) as formed over the course of the method for producing the battery.

A respective electrolyte can be arranged in the space between the respective end plate and the respectively adjacent bipolar plate, or between the respective end plate active material associated with a respective end plate and the first or second active material of the respective adjacent bipolar plate respectively, which can be at least partly surrounded by a respective spacer frame and/or can be held and/or accommodated by same, and can preferably also be at least partly surrounded by a frame of the adjacent bipolar plate and/or by the surrounding projection or surrounding frame of the respective end plate.

In an embodiment, the electrolyte can be formed as a solid electrolyte, for instance as a thin ceramic or sulfidic solid electrolyte, which is, for example, introduced or arranged in a receiving space of the spacer frame or held in same respectively. In another embodiment, the electrolyte can be formed as a liquid electrolyte, wherein a separator, for example in the form of a glass (fiber) mat, can be provided which is soaked with the liquid electrolyte and can for example be accommodated or introduced or arranged in the receiving space of the spacer frame.

The respective electrolyte arranged between adjacent bipolar plates is thereby both in contact with the first active material of a bipolar plate of adjacent bipolar plates as well as in contact with the second active material of the other bipolar plate of adjacent bipolar plates in order to connect the respective adjacent bipolar plates in electrically conductive manner.

Furthermore, the respective electrolyte arranged between a respective bipolar plate and a respective end plate is both in contact with the first/second active material of the respective bipolar plate as well as in contact with the respective end plate active material associated with the respective adjacent end plate in order to connect the respective bipolar plate to the respectively adjacent connecting plate in electrically conductive manner. In so doing, the two connecting plates, and thus also the first and second terminal posts of the battery, are connected together in electrically conductive manner by the end plate active materials, the electrolytes and the plurality of bipolar plates.

According to an embodiment, at least one of the spacer frames can be omitted. In this case, the frames of the adjacent bipolar plates and/or the respective surrounding projection or frame of a respective end plate are or can be connected to the frame of the adjacent bipolar plate, particularly in fluid-tight manner, in order to form a respective space in which the respective electrolyte is accommodated or introduced or arranged.

According to an embodiment, the method for producing the battery furthermore comprises the providing of a housing, in particular a multi-part housing, and an arranging of the housing such that it encloses and/or surrounds the end plates, the multiple bipolar plates arranged therebetween and, if applicable, the spacer frames. In this case, the first and second terminal posts of the battery can be formed on an outer face of the housing or respectively outside of the housing.

According to a preferential embodiment, a battery, in particular a bipolar battery, e.g. a bipolar lead-acid battery, is produced using an above-described method for producing a battery, in particular a bipolar battery.

Further advantageous developments of the present invention are yielded by the following description of preferential embodiments. Thereby shown, at least in part schematically:

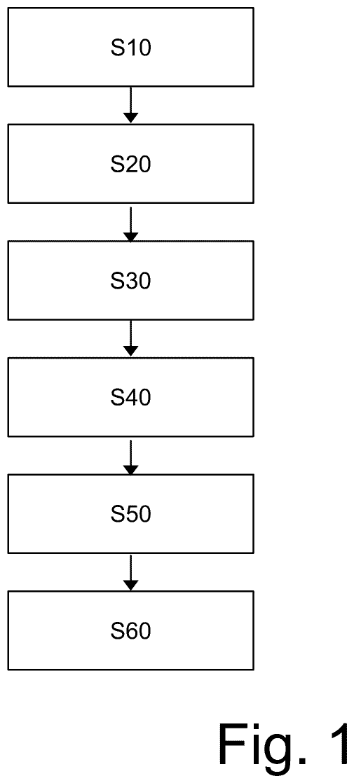

FIG. 1 a flow chart illustrating a method for producing a leaded plate for a battery which has at least one projection according to a preferential embodiment,

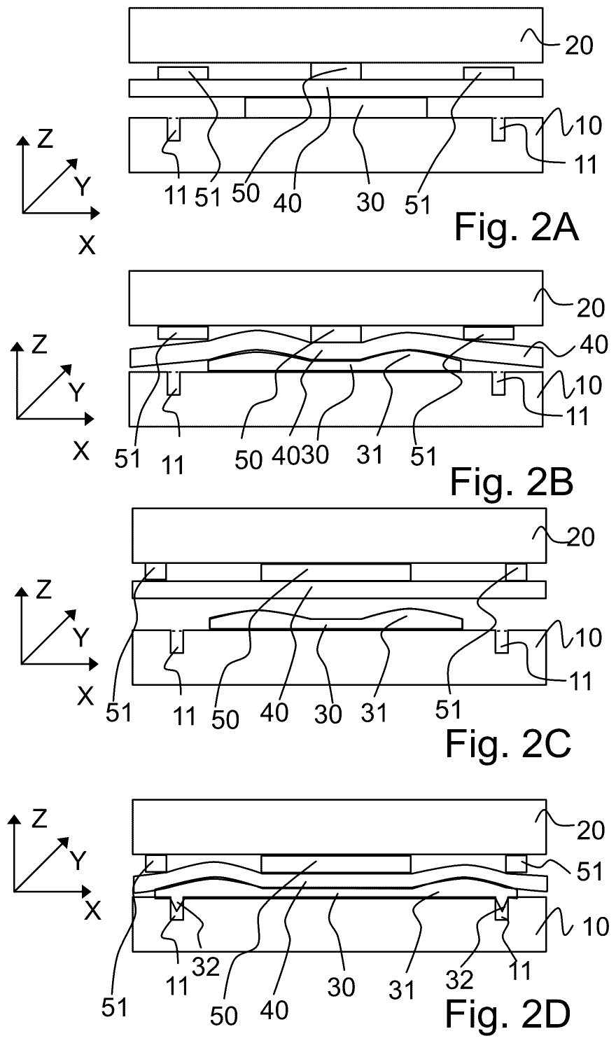

FIGS. 2A-2D depictions illustrating different phases of the method for producing a leaded plate for a battery having at least one projection,

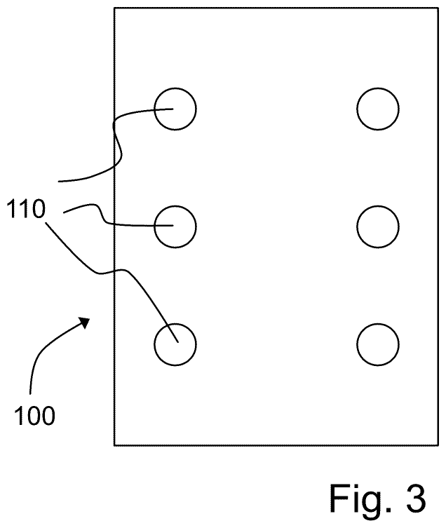

FIG. 3 a top plan view of a leaded plate having at least one projection produced by means of the inventive method,

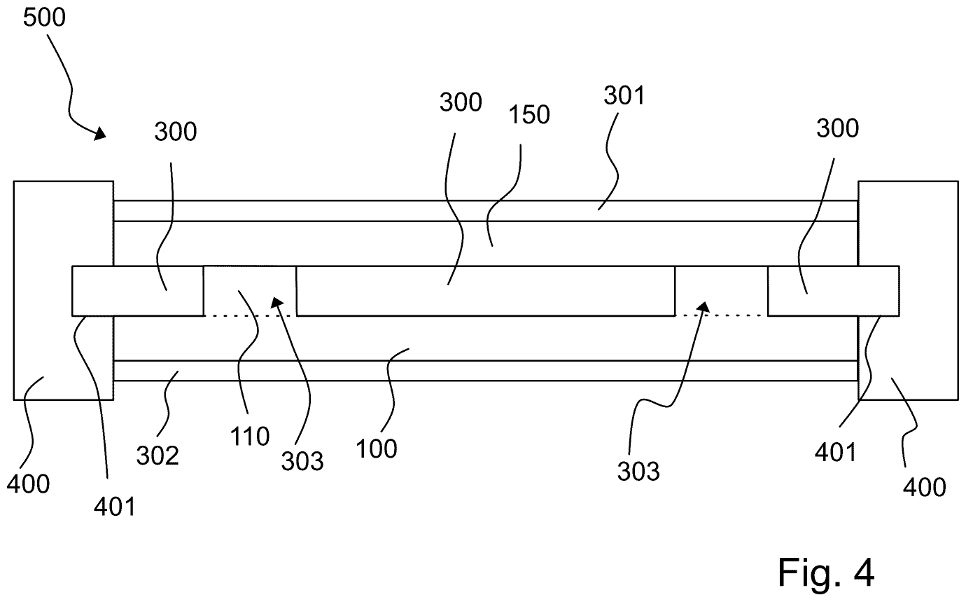

FIG. 4 a cross-sectional view of a bipolar plate for a battery according to a preferential embodiment, and

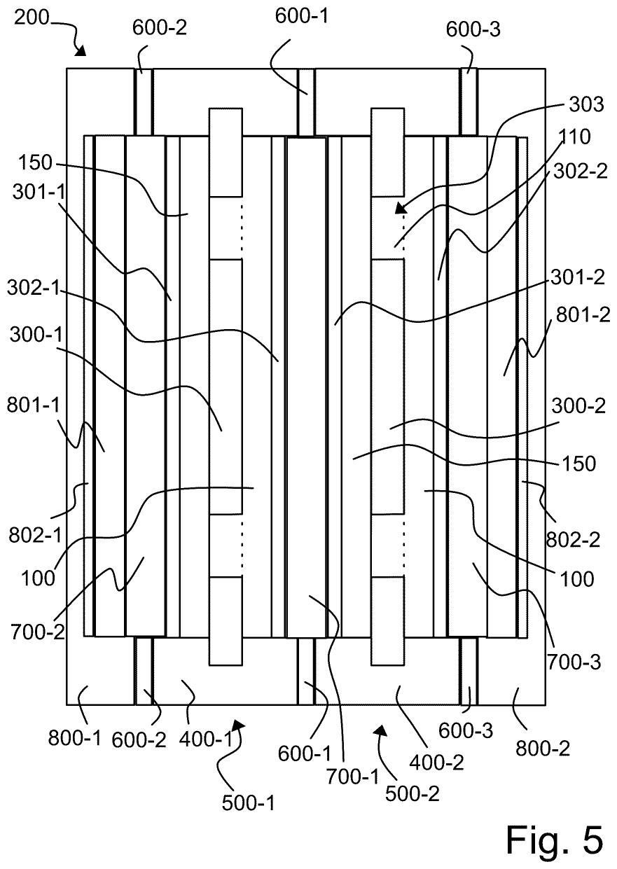

FIG. 5 a cross-sectional view of a battery according to a preferential embodiment.

FIG. 1 shows a flow chart for the purpose of illustrating a method for producing a leaded/lead-containing plate 100 or film 100 for a battery 200 having at least one projection 110 according to a preferential embodiment illustrated in FIG. 3 or FIG. 5 respectively. The leaded plate/film 100 having the at least one projection 110 is in particular provided for use in a bipolar battery as well as in a bipolar battery 200 such as a bipolar lead-acid battery in which multiple pairs of plate/film 100 and a further plate/film 100 or a substantially planar leaded plate 150 are stacked atop one another (see FIGS. 4 and 5) and the at least one projection 110 serves as a current path between the two plates 100,150 of a respective pair.

In step S10 of FIG. 1, with reference to FIG. 2A, a leaded/lead-containing workpiece 30 is provided. The leaded workpiece 30 can be a pure lead material with a lead content of 100% or nearly 100%. However, the provided leaded workpiece 30 can also be a lead alloy containing an additional material besides lead. The additional material is preferably able to reduce the forming or thickness of a passivation layer as commonly occurs with pure lead material and/or increase the strength of the workpiece 30 and/or reduce corrosion of the workpiece 30. The additional material can thereby preferably contain calcium and/or zinc and/or silver and/or tin and/or another appropriate metal. Preferentially, the leaded workpiece 30 is a lead-tin alloy having a tin content of 0.8% to 1.5%, preferably a tin content of 1.4%, which in an embodiment, additionally contains calcium at a calcium content of e.g. 0.05% to 0.1%, preferably a calcium content of 0.08%, and/or can contain other metals such as silver or antimony.

The leaded workpiece 30 provided is preferentially a cohesive material such as a leaded plate, as illustrated in FIG. 2A, which is preferably cube-shaped or rectangular and can exhibit the dimensions of approximately 0.5-1.1 mm×70-150 mm×70-500 mm; in one realization 0.9 mm×70-75 mm×175-180 mm. According to an embodiment, the workpiece 30 designed as a leaded plate is produced by means of casting and/or milling and, if needed, reannealing.

In a preferential embodiment, the leaded workpiece 30 is or is to be produced by means of an extrusion process using an appropriate extrusion apparatus. The extrusion enables a leaded extrudate to be produced or respectively provided as the workpiece 30 which is more pliable, or exhibits greater elasticity respectively, than a corresponding leaded plate produced by casting and/or milling. This thereby advantageously enables forgoing reannealing of the extrusion-produced workpiece 30 as a leaded extrudate as is normally necessary in the case of leaded plates produced by casting and/or milling in order to obtain the material properties required for subsequent steps of the method as regards deformability. In addition, the workpiece 30 produced by extrusion and formed as a leaded extrudate advantageously exhibits smaller particle sizes than the corresponding workpiece 30 produced via milling and/or casting and/or reannealing.

In step S20, a tool is provided, in particular a press tool, preferably a hydraulic press or an eccentric press, having a lower die 10 and an upper die 20 as illustrated in FIG. 2A. The lower die 10 thereby comprises at least one recess 11 designed for part of the workpiece 30, or a portion of the material of the workpiece 30 respectively, to flow into in order to form the at least one projection 110. The at least one recess 11 can preferably be formed by a boring through the lower die 10 into which a pin, preferably a ground pin, extends from below by a predetermined amount depending on the specifications, whereby a depth of the recess 11 is adjustable. The pin can be moved during the method and in particular after completion of the leaded plate 100 such that it partly or completely fills the boring and thus acts as an ejector.

Preferentially, the tool has six such recesses 11, whereby the diameters of the recesses 11 are adapted to the diameters of the projections 110 to be formed and are preferably approximately 9 mm. In a not-shown embodiment, the upper die 20 can additionally or alternatively exhibit such recesses 11.

In step S30, the leaded workpiece 30 is arranged between the lower die 10 and the upper die 20. The workpiece 30 is thereby arranged, as illustrated in FIG. 2A, so as not to overlap with the at least one recess 11 along a first direction Z, along which a relative motion occurs between the upper die 20 and the lower die 10 in a subsequently following step S60, or pressing step S60 or punching step S60 respectively.

In step S40, a deformable, in particular elastically deformable and preferably planar intermediate plate 40 is arranged between the workpiece 30 and the upper die 20 as in the embodiment illustrated in FIG. 2A. In the other not-shown embodiment, in which the at least one recess 11 is provided in the upper die 20, the deformable intermediate plate 40 is arranged between the workpiece 30 and the lower die 10.

In step S50, a first strip 50, or center strip 50 respectively, and at least one second strip 51 are arranged at a spacing from one another along a second direction X running perpendicular to the first direction Z; in the embodiment shown in FIG. 2A, two second strips 51, or two lateral strips 51 respectively, are arranged between the intermediate plate 40 and the upper die 20. In contrast, in the other not-shown embodiment, a first strip 50, or center strip 50 respectively, and at least one second strip 51 are arranged at a spacing along the second direction X, preferentially two second strips 51 or two lateral strips 51 are arranged between the intermediate plate 40 and the lower die 10. The first strip 50 is thereby arranged such that it overlaps the workpiece 30 along the first direction Z, preferentially in the center of the workpiece 30, and the at least one second strip 51 is arranged so as to not overlap the workpiece 30 along the first direction Z. In the case in which two second strips 51 are used, the first strip 50 is arranged so as to be between the two second strips 51 along the second direction X, wherein the two second strips 51 are arranged symmetrically with respect to the first strip 50.

In an embodiment, the first strip 50 and/or the at least one second strip 51 can thereby be fixed to the intermediate plate 40 in order to form a combined component consisting of the combination of the intermediate plate 40, the first strip 50 and/or the at least one second strip 51 or to form a combination of the intermediate plate 40, the first strip 50 and/or the at least one second strip 51 as a single-piece component so that steps S40 and S50 can be performed at the same time. Furthermore, a retaining device can be provided on the tool, by means of which the position of the combined component or single-piece component is fixed along the second direction X. This thereby enables achieving high repetition accuracy when successively producing a plurality of leaded plates 100 having at least one projection 110.

In another embodiment, a retaining device can also be provided on the tool, by means of which the position of the first strip 50 and/or the at least one second strip 51 is fixed along the second direction X. This thereby likewise enables achieving high repetition accuracy when producing a plurality of leaded plates 100 with at least one projection 110.

As illustrated in FIG. 2B, in a step S60 or respectively pressing step S60 or punching step S60, a relative motion is executed between the upper die 20 and the lower die 10 along the first direction Z, whereby a distance between the upper die 20 and the lower die 10 is reduced in order to exert a pressure on the workpiece 30 via the intermediate plate 40, the first strip 50 and the at least one second strip 51 and thereby effect a flowing movement of the material of the workpiece 30 in the second direction X.

Preferentially, the position of the lower die 10 remains unchanged during this relative motion while the upper die 20 is moved toward the lower die 10. Furthermore, not-shown drilled guide holes can be provided in the upper die 20 and/or lower die 10 through which a plug or a pillar passes so to guide the relative movement through a pillar guide.

According to the invention, at least steps S50 and S60 are performed or respectively repeated multiple times one after the other, preferably at least five times, preferentially at least ten times, particularly preferentially at least 18 times, in order to ensure that at least a portion of the material of the workpiece 30 flows into the at least one recess 11 and thus produces the leaded plate or film 100 having the at least one projection 110.

In a preferential embodiment, step S40 can also be executed repeatedly beforehand in at least one repetition of steps S50 and S50. In other words, use can be made of another intermediate plate 40 in this embodiment prior to the repeated execution of steps S50 and S60 than in a preceding repetition of at least steps S50 and S60. Steps S50 and S60 are thereby preferably executed at least five times in a row, preferentially at least ten times, particularly preferentially at least 18 times, and with at least one repetition of step S40.

This thereby results in a preferential embodiment in such a positioning of the first strip 50 and the at least one second strip 51 relative to the second direction X as well as a respective selection of the widths of the first strip 50 and/or the at least one second strip 51 along the second direction X in the individual repetitions that the at least one recess 11 is gradually filled with a portion of the material of the workpiece 30.

Thus, as illustrated by comparing FIGS. 2C and 2D, which illustrate a repeated execution of steps S40, S50 and S60, to FIGS. 2A and 2B, use is preferentially made of a different, preferably planar intermediate plate 40 than in the previously executed step S40 and respective first strips 50 of an increasing width, measured in the second direction X, with an increasing number of repetitions.

Furthermore, as illustrated by comparing FIGS. 2C and 2D to FIGS. 2A and 2B, preferentially at least one of the at least one second strips 51 is arranged at a different position with respect to the second direction X than in a previous execution of step S50 in order to have at least a portion of the material of the workpiece 30 flow into the at least one recess 11 so as to form the at least one projection 110. The at least one of the at least two second strips 51 can thereby be arranged upon at least one repetition of step S50 so as to have a greater distance from the first strip 50 and/or from the other one of the at least two strips 51, measured along the second direction X, than in a previous execution of step S50.

In particular, as illustrated in FIGS. 2A to 2D, with at least one repetition of step S50, preferably with each repetition, the first strip 50 and two second strips 51 are arranged such that the first strip 50 is arranged between the two second strips 51, whereby the two second strips 51 are arranged such that in the immediately following step S60, the flowing movement of the material of the workpiece 30 is at least limited by a deformation of the intermediate plate 40 along the second direction X effected by the two second strips 51, as illustrated in FIGS. 2B and 2D, and thus forcing a flow of a portion 32 of the material of the workpiece 30 into the at least one recess 11, as illustrated in FIG. 2D.

Moreover, as illustrated in FIGS. 2A to 2D, the first strip 50 and the two second strips 51 can be arranged parallel to each other in step S50, wherein the first strip 50 is arranged in the center between the two second strips 51 and a distance between the two second strips 51 is greater with at least one repetition, preferably with each repetition of step S50, than in a previous execution of step S50.

As illustrated in FIGS. 2B and 2D, upon at least one execution of step S60, the intermediate plate 40 is deformed such that an accumulation of part of the material of the workpiece 30 is formed between the first strip 50 and the two second strips 51, namely mound 31, during or subsequent the execution of step S60, wherein a thickness of the material of the workpiece 30 is greater at a position arranged between the first strip 50 and the two second strips 51 than at a position at which the first strip 50 overlaps the workpiece along the first direction Z and/or is greater than at a position at which the at least one second strip 51 overlaps the workpiece 30 along the first direction Z.

The tool provided in step S20 preferentially comprises a not-shown device preferably designed in the form of boundary plates and configured to limit flowing movement of the material of the workpiece 30 during step S60 in a third direction Y, which is perpendicular to the first direction Z and perpendicular to the second direction X, so as to obtain a leaded plate 100 of a predetermined length for a battery 200 which has at least one projection 110. Preferably, said device is further configured to limit the flow movement of the material of the workpiece 30 in the second direction X during step S60.

After the last repetition of steps S50 and S60 has been performed, the at least one recess 11 is completely filled with a portion 32 of the material of the workpiece 30 (not shown) and thus the plate 100 for a battery 200 having at least one projection 110 produced. If required, a length and/or width of the thusly produced plate 100 can be shortened in an optional subsequent work step by an appropriate tool, for example by a punch tool, such that the plate 100 subsequently exhibits a predetermined length and/or predetermined width.

According to one (not illustrated) embodiment, a leaded workpiece 30 is provided in step S10 which has a profile with a thickness measured in or respectively along the first direction Z, particularly after the workpiece 30 is arranged between the lower die 10 and the upper die 20 in step S30, which varies along the second direction X in a cross section along a plane spanned by the first direction Z and the second direction X.

In a case in which an extrusion process is used to produce or respectively provide the leaded workpiece 30 in step S10, the corresponding design to the leaded workpiece 30 can be achieved by utilizing a (counter) die shaped in conformity with the desired profile, and in a case in which a milling process is used to produce or respectively provide the leaded workpiece 30 in step S10, by making use of a longitudinal rolling process executed in conformity with the profile desired.

Preferentially, a leaded workpiece 30 with a profile is thereby provided in step S10, the thickness of which is greater in two areas arranged substantially symmetrically about a center of the leaded workpiece 30 arranged with respect to the second direction X than in other areas. The difference in thickness between the two areas arranged substantially symmetrically about a center of the leaded workpiece arranged with respect to the second direction and the other areas can thereby amount to e.g. 0.3 mm to 2 mm.

FIG. 3 shows a top plan view of a leaded plate having at least one projection produced by the inventive method.

The leaded plate 100 having at least one projection 110 for a battery 200, in particular a bipolar battery, for example a bipolar lead-acid battery, has a plurality of projections 110, in the present case six, arranged in two rows and three columns, their height preferably in a range of from 0.4 mm to 1.5 mm, preferentially a range of from 1.0 mm to 1.2 mm, and particularly preferentially 1.1 mm, and their diameter in a range of from 7 to 25 mm, and preferably approximately 8 to 10 mm.

FIG. 4 shows a schematic cross-sectional view of a bipolar plate for a battery according to a preferential embodiment which exhibits a leaded plate for a battery having at least one projection produced by the inventive method for producing a leaded plate having at least one projection and can be produced utilizing the inventive method for producing a bipolar plate.

The bipolar plate 500 comprises a preferably rectangular and electrically insulating frame 400 having an internal groove 401, a substrate 300 with at least one opening 303, in particular multiple openings 303, particularly passage opening(s), a leaded plate 100 having at least one projection 110 produced according to the inventive method for producing a plate for a battery having at least one projection, a substantially planar leaded plate or film 150, a first (positive or negative) active material 301 and a second active material 302, wherein the second active material 302 is a negative active material when the first active material 301 is a positive active material and the second active material 302 is a positive active material when the first active material 301 is a negative active material.

The frame 400, the substrate 300, the plate 100 having the at least one projection 110, and the substantially planar leaded plate or film 150 can be provided when executing the inventive method for producing the bipolar plate 500.

The substantially planar leaded plate or film 150 can in particular be of or made from the same material or a substantially identical material as the workpiece 30, or the leaded plate 100 having the at least one projection 110 respectively, and apart from the projections 110, can exhibit the same or substantially the same dimensions as the leaded plate 100 having the at least one projection 110. Furthermore, the substantially planar leaded plate or film 150 can be produced by means of an extrusion process using an extrusion apparatus such as a (counter) die shaped in conformity with the substantially planar profile of the substantially planar leaded plate or by means of a milling and/or casting process and/or reannealing.

The frame 400 is or can be arranged such that the substrate 300, the leaded plate 100 having the at least one projection 110, the substantially planar leaded plate 150, the first active material 301 and the second active material 302 are respectively surrounded laterally by the frame 400 which is preferably formed from an electrically insulating material and in particular serves as housing for the remaining components of the bipolar plate 500. An outer lateral portion of the substrate 300 is or can thereby be accommodated or respectively inserted into the groove 401 of the frame 400, whereby the substrate 300 is held and supported by the frame 400.

In an embodiment, the substrate 300 can be formed from, for example, an electrically insulating material such as plastic or can comprise or consist of same. In an embodiment, the substrate 300 can comprise an electrically insulating material forming or at least substantially forming an outer form of the substrate 300 and in which electrically conductive elements such as electrically conductive particles, electrically conductive fibers and/or a conductive powder are provided in a preferably homogeneous distribution.

The leaded plate 100 having the at least one projection 110 is arranged on, applied onto or provided on a main face of the substrate 300 such that the projections 110 respectively extend into and preferably through a corresponding opening 303, in particular passage opening, of the substrate 300, wherein the substantially planar leaded plate 150 is arranged on, applied onto or provided on the other main face, which faces away from the one main face of the substrate 300, of the substrate 300 and the end of a respective one of the projections 110 facing the substantially planar leaded plate 150 is or can be electrically connected conductively to the substantially planar leaded plate 150 using an appropriate connection technique, preferably welding, in particular resistance welding, or soldering.

A respective adhesive layer (not shown) can thereby be applied or arranged between the main face of the substrate 300 and the leaded plate 100 with the at least one projection 110 and/or between the other main face of the substrate 300 and the substantially planar leaded plate 150 in order to fix the leaded late 100 with the at least one projection 110 and/or the substantially planar leaded plate 150 to the substrate 300.

The height of the at least one projection 110 of the leaded plate 100 having the at least one projection 110 is thereby preferentially selected so as to equal or substantially equal a thickness of the substrate 300 or, when one or two adhesive layer(s) is/are applied to fix the leaded plate 100 with the at least one projection 110 and/or the substantially planar leaded plate 150 to the substrate, so as to equal or substantially equal a sum total of the thickness of the substrate 300 and the adhesive layer(s).

The first active material 301 is provided on or applied to a main face, which faces away from the substrate 300, of the substantially planar leaded plate 150 and the second active material 302 is provided on or applied to a main face, which faces away from the substrate 300, of the leaded plate 100 having the at least one projection 110. Application of the first and/or second active material 301, 302, in particular so as to form a layer of the first or second active material 301, 302, can for example comprise coating the respective main face with a paste comprising the first or second active material 301, 302 and a subsequent thermal treatment.

The thicknesses and arrangements of the substrate 300, the leaded plate 100 having the at least one projection 110, the substantially planar leaded plate 150, the first active material 301 and the second active material 302 are thereby selected such that a total thickness of the arrangement is less than a thickness of the frame 400 and in particular selected such that the free space above exposed surfaces of the first and second active material 301, 302 is laterally limited by the frame 400.

In a not-shown embodiment, the substrate 300 can be integrally formed with the frame 400; the substrate 300 and the frame together thus formed by a single piece.

Additionally or alternatively, instead of the substantially planar leaded plate or film 150, the bipolar plate 500 in a not-shown embodiment can comprise a further leaded plate 100 having at least one projection 110 which is able to be provided when executing the inventive method for producing the bipolar plate 500.

The further leaded plate 100 having at least one projection 110 is thereby provided in the method and arranged on the other main face of the substrate 300 such that the respective projections 110 extend into the corresponding openings 303 of the substrate 300, whereby an electrically conductive connection is established between the end of the at least one projection 110 of the leaded plate 100 having the at least one projection 110 and the end of the at least one projection 110 of the further leaded plate 100 having the at least one projection 110 using an appropriate connection technique, preferably welding, in particular resistance welding, or soldering.

A respective adhesive layer can thereby be applied or arranged between the main face of the substrate 300 and the leaded plate 100 with the at least one projection 110 and/or between the other main face of the substrate 300 and the further leaded plate 150 having at least one projection 110 in order to fix the leaded plate 100 having the at least one projection 110 and/or the further leaded plate 150 having the at least one projection 110 to the substrate 300.

In this case, the height of the at least one projection 110 of the leaded plate 100 having the at least one projection 110 and the height of the at least one projection 110 of the further leaded plate 100 having the at least one projection 110 is preferentially selected so as to equal or substantially equal half the thickness of the substrate 300 or, when one or two adhesive layer(s) is/are applied to fix the leaded plate 100 having the at least one projection 110 and/or further leaded plate 100 having the at least one projection 110 to the substrate 300, so as to equal or substantially equal half the sum total of the thickness of the substrate 300 and the adhesive layer(s). In another embodiment, the height of the at least one projection 110 of the leaded plate 100 having the at least one projection 110 and the height of the at least one projection 110 of the further leaded plate 100 having the at least one projection 110 is in this case selected such that the sum total of the two heights equals or substantially equals the thickness of the substrate 300 or, when one or two adhesive layer(s) is/are applied to fix the leaded plate 100 having the at least one projection 110 and/or the further leaded plate 100 having the at least one projection 110 to the substrate 300, so as to equal or substantially equal the sum total of the thicknesses of the substrate 300 and the adhesive layer(s).

Furthermore, the first active material 301 in this case is provided on or applied to the main face, which faces away from the substrate 300, of the further leaded plate 100 having the at least one projection 110.

In the method according to the invention for producing the bipolar plate 500 for a battery 200, particularly bipolar battery, in particular the substrate 300 with at least one opening 303, the leaded plate 100 for a battery 200 having at least one projection produced by means of the above-described method for producing a leaded plate 100 for a battery 200 having at least one projection 110, and the further leaded plate 100 having the at least one projection 110 produced by means of the above-described method for producing a leaded plate 100 for a battery 200 having at least one projection or the substantially planar leaded plate 150 are provided.

Further occurring in the method according to the invention for producing a bipolar plate 500 for a battery 200 is in particular
arranging the leaded plate 100 having the at least one projection 110 on a main face of the substrate 300 such that the at least one projection 110 extends into the at least one opening 303 of the substrate 300, arranging the further leaded plate 100 having the at least one projection 110 on another main face of the substrate 300 such that the at least one projection 110 extends into the at least one opening 303 of the substrate 300 and establishing an electrically conductive connection between one end of the at least one projection 110 of the leaded plate 100 having the at least one projection 110 and one end of the at least one projection 110 of the further leaded plate 100 having at least one projection, wherein the end of the at least one projection 110 of the leaded plate 100 having the at least one projection and the end of the at least one projection 110 of the further leaded plate 100 having the at least one projection face each other, and applying a first active material 301 onto a main face, which faces away from the substrate 300, of the further leaded plate 100 having the at least one projection and applying a second active material 302 onto a main face, which faces away from the substrate 300, of the leaded plate 100 having the at least one projection, or
arranging the leaded plate 100 having the at least one projection 110 on a main face of the substrate 300 such that the at least one projection 110 extends through the at least one opening 303 of the substrate 300, arranging the substantially planar leaded plate 100 on another main face of the substrate 300, and establishing an electrically conductive connection between the end of the at least one projection 110 of the leaded plate 100 having the at least one projection 110 facing the substantially planar leaded plate 150 and the substantially planar leaded plate 150, and applying a first active material 301 onto a main face, which faces away from the substrate 300, of the substantially planar leaded plate 150 and applying a second active material 302 onto a main face, which faces away from the substrate 300, of the leaded plate 100 having the at least one projection.

The inventive method for producing a bipolar plate 500 for a battery 200 can in particular further comprise a providing of the frame 400 and an arranging of the frame 400 such that the frame 400 laterally surrounds the substrate 300, the leaded plate 100 having the at least one projection 110, the further leaded plate 100 having the at least one projection 110 or the substantially planar leaded plate 150, the first active material 301 and the second active material 302 such that the frame 400 in the finished bipolar plate 500 laterally limits a free space above exposed surfaces of the first and second active material 301, 302.

The providing of the frame 400 can thereby comprise a providing of a frame 400 formed integrally with the substrate 300 or the providing of the frame 400 comprises a providing of a frame 400 having an internal groove 401, whereby a lateral section of the substrate 300 is inserted into the groove 401.

FIG. 5 shows a schematic cross-sectional view of a battery according to a preferential embodiment able to be produced using the inventive method for producing a battery.

The battery 200, in particular bipolar battery, e.g. bipolar lead-acid battery, comprises a plurality of bipolar plates 500 as illustrated in FIG. 4, whereby only two bipolar plates 500-1, 500-2 are depicted in FIG. 5 for reasons of clarity. The bipolar plates 500-1, 500-2 are or are to thereby be stacked atop one another such that the main faces, which face away from the substrate 300-1, 300-2, of the first active material 301-1, 301-2 of a respective bipolar plate 500-1, 500-2 point in the same direction, in the example of FIG. 5 to the left.

A respective spacer frame 600-1 is or is to be provided or arranged between the respective frames 400-1, 400-2 of adjacent bipolar plates 500-1, 500-2 which separates the respective frames 400-1, 400-2 of the adjacent bipolar plates 500-1, 500-2 and is or is to be preferentially connected to the two frames 400-1, 400-2 of the adjacent bipolar plates 500-1, 500-2 such that a space is or is to be formed between the two adjacent bipolar plates 500-1, 500-2, in particular between the facing first and second active materials 301-2, 302-1 of the adjacent bipolar plates 500-1, 500-2, which in particular can be sealed in fluid-tight manner and in which the electrolyte described below is accommodated or introduced or arranged.

A respective end plate 800-1, 800-2 is or is to be provided or arranged at a respective end of the stack of bipolar plates 500-1, 500-2, wherein a respective spacer frame 600-2, 600-3 is or is to be provided or arranged between a surrounding projection or surrounding frame of a respective end plate 800-1, 800-2 and the frame 400-1, 400-2 of the respective adjacent bipolar plate 500-1, 500-2 which separates the respective frame 400-1, 400-2 of the respective bipolar plate 500-1, 500-2 and the surrounding projection or surrounding frame of the respective end plate 800-1, 800-2 and preferentially is or is to be connected to the respective frame 400-1, 400-2 of the respective bipolar plate 500-1, 500-2 and the surrounding projection or surrounding frame of the respective end plate 800-1, 800-2 such that a space is formed between the respective end plate 800-1, 800-2 and the respective adjacent bipolar plate 500-1, 500-2 which in particular can be sealed in fluid-tight manner and in which the electrolyte described below is to be accommodated or introduced or arranged.

A respective (positive or negative) end plate active material 801-1, 801-2 is or is to be provided on or applied to a side of a respective end plate 800-1, 800-2 facing a respective adjacent bipolar plate 500-1, 500-2, wherein a respective connecting plate 802-1, 802-2 is or is to be arranged between the respective end plate 800-1, 800-2 and the respective end plate active material 801-1, 801-2 which is in particular to be electrically connected conductively to the respective end plate active material 801-1, 801-2 and a respective (not shown) first or second terminal post of the battery 200 (plus/minus terminal post of the battery 200).

Furthermore, a respective electrolyte 700-1, 700-2, 700-3 is or is to be arranged between the first active material 301-2 of a respective bipolar plate 500, e.g. bipolar plate 500-2 in FIG. 5, and the second active material 302-1 of a respective adjacent bipolar plate 500, e.g. bipolar plate 500-1 in FIG. 5, and between the respectively end plate active material 801-1, 801-2 associated with a respective end plate 800-1, 800-2 and the first or second active material 301-1, 302-2 of the respective adjacent bipolar plate 500-1, 500-2 which is at least partly surrounded by a respective spacer frame 600-1, 600-2, 600-3 and/or held and/or accommodated by same, and preferably also at least partly surrounded by at least one frame 400-1, 400-2 of the adjacent bipolar plate 500-1, 500-2, preferentially by both frames 400-1, 400-2 in the case of electrolyte 700-1, and in the case of electrolyte 700-2, 700-3, also by the surrounding projection or surrounding frame of the respective end plate 800-1, 800-2.

In an embodiment, the electrolyte 700-1, 700-2, 700-3 can be formed as a solid electrolyte, for instance as a thin ceramic or sulfidic solid electrolyte which is, for example, introduced or arranged in a receiving space of the spacer frame 600-1, 600-2, 600-3 or held in same respectively. In another not-shown embodiment, the electrolyte 700-1, 700-2, 700-3 can be formed as a liquid electrolyte, wherein a separator, for example in the form of a glass (fiber) mat, can be provided which is soaked with the liquid electrolyte and can for example be accommodated or introduced or arranged in the receiving space of the spacer frame 600-1, 600-2, 600-3.

The respective electrolyte 700-1 arranged between adjacent bipolar plates 500 is thereby both in contact with the first active material 301-2 of a bipolar plate 500, bipolar plate 500-2 in FIG. 5, as well as in contact with the second active material 302-1 of the respective adjacent bipolar plate 500, bipolar plate 500-1 in FIG. 5, in order to connect the respective adjacent bipolar plates in electrically conductive manner.

Furthermore, the respective electrolyte 700-2, 700-3 arranged between a respective bipolar plate 500-1, 500-2 and a respective end plate 800-1, 800-2 is both in contact with the first/second active material 301-1, 302-2 of the respective bipolar plate 500-1, 500-2 as well as in contact with the respective end plate active material 801-1, 801-2 associated with the respective adjacent end plate 800-1, 800-2 in order to connect the respective bipolar plate 500-1, 500-2 to the respectively adjacent connecting plate 802-1, 802-2 in electrically conductive manner. In so doing, the two connecting plates 802-1, 802-2, and thus also the not-shown first and second terminal posts of the battery 200, are connected together in electrically conductive manner by the end plate active materials 801-1, 801-2, the electrolytes 700-1, 700-2, 700-3 and bipolar plates 500-1, 500-2.

In a not-shown embodiment, the substrate 300 can be integrally formed with the frame 400; the substrate 300 and the frame together thus formed by a single piece.

Additionally or alternatively, in a not-shown embodiment, at least one of the spacer frames 600-1, 600-2, 600-3 can be omitted. In this case, the frames 400-1, 400-2 of the adjacent bipolar plates 500-1, 500-2 and/or the respective surrounding projection or frame of a respective end plate 800-1, 800-2 are or can be connected to the frame 400-1, 400-2 of the adjacent bipolar plate 500-1, 500-2, particularly in fluid-tight manner, in order to form a respective space in which the respective electrolyte is accommodated or introduced or arranged.

Additionally or alternatively, in a not-shown embodiment, the battery 200 can further comprise a housing, in particular a multi-part housing, which encloses and/or surrounds the end plates 800-1, 800-2, the bipolar plates 500-1, 500-2 arranged therebetween and, if applicable, the spacer frames 600-1, 600-2, 600-3, and which is provided and arranged when executing the method for producing the battery 200 so as to enclose and/or surround the end plates 800-1, 800-2, the bipolar plates 500-1, 500-2 arranged therebetween and, if applicable, the spacer frames 600-1, 600-2, 600-3.

Additionally or alternatively, in a not-shown embodiment, instead of the substantially planar leaded plate or film 150, at least one of the bipolar plates 500-1, 500-2 can comprise the further leaded plate 100 having the at least one projection 110, the configuration and production of which are described with reference to FIG. 4.

The inventive method for producing a battery 200, particularly a bipolar battery, in particular comprises:
stacking multiple bipolar plates 500, 500-1, 500-2 produced by means of an above-described method for producing a bipolar plate for a battery atop one another such that the respective first active materials 301, 301-1, 301-2 of the individual bipolar plates 500 point in the same direction in order to form a stack of bipolar plates 500, 500-1, 500-2, wherein a respective electrolyte 700-1 is arranged between a respective pair of adjacent bipolar plates 500, 500-1, 500-2, in particular between the facing first and second active materials of the adjacent bipolar plates 500-1, 500-2, such that the respective electrolyte 700-1 is both in contact with the first active material 301, 301-1, 301-2 of one bipolar plate 500, 500-1, 500-2 of the pair of bipolar plates 500, 500-1, 500-2 as well as in contact with the second active material 302, 302-1, 302-2 of the other bipolar plate 500, 500-1, 500-2 of the pair of bipolar plates 500, 500-1, 500-2, and
establishing an electrically conductive connection between the first active material 300, 300-1, 300-2 arranged on the main face, which faces away from the stack of bipolar plates 500, 500-1, 500-2, of a first bipolar plate 300, 300-1, 300-2 of the stack of bipolar plates 500, 500-1, 500-2 and a first terminal post of the battery 200, as well as
   establishing an electrically conductive connection between the second active material 300, 300-1, 300-2 arranged on the main face, which faces away from the stack of bipolar plates 500, 500-1, 500-2, of a last bipolar plate 300, 300-1, 300-2 of the stack of bipolar plates 500, 500-1, 500-2 and a second terminal post of the battery 200.

1. A method for producing a leaded plate for a battery which has at least one projection, the method comprising: the steps:
a) providing a leaded workpiece,
b) providing a tool having a lower die and an upper die, wherein the lower die and/or the upper die have at least one recess,
c) arranging the workpiece between the lower die and the upper die,
d) arranging a deformable intermediate plate between the workpiece and the upper die or lower die,
e) arranging a first strip and at least one second strip between the intermediate plate and the upper die or the lower die on a side of the intermediate plate facing away from the workpiece,
f) executing a relative motion between the upper die and the lower die along a first direction which reduces a distance between the upper die and the lower die in order to exert pressure on the workpiece via the intermediate plate, the first strip and the at least one second strip and thereby effect a flowing movement of the material of the workpiece in a second direction running perpendicular to the first direction, wherein
the first strip and the at least one second strip are arranged spaced at a distance from one another along the second direction in step e), and
steps e) and f) are repeated multiple times so as to effect at least a portion of the material of the workpiece flowing into the at least one recess in order to form the at least one projection.

2. The method according to claim 1, wherein a first strip is arranged upon at least one repetition of step e) which has a larger width, measured along the second direction, than a width of a first strip arranged in a previous execution of step e).

3. The method according to claim 1, wherein upon at least one repetition of step e), at least one of the at least one second strips is arranged in a different position relative to the second direction as in a previous execution of step e).

4. The method according to claim 1, wherein the workpiece is arranged in step c) so as to not overlap the at least one recess along the first direction.

5. The method according to claim 1, wherein a first strip and two second strips are arranged in such a manner in step e) that the first strip is arranged between the two second strips and the two second strips are arranged such that in the immediately following step f), the flowing movement of the material of the workpiece in the second direction is at least limited by a deformation of the intermediate plate effected by the two second strips.

6. The method according to claim 5, wherein a first strip and two second strips are arranged parallel to each other in step e), the first strip being arranged in the center between the two second strips, and a distance between the two second strips, measured along the second direction, is greater upon at least one repetition of step e) than in a previous execution of step e).

7. The method according to claim 6, wherein the two second strips are arranged symmetrically with respect to the first strip in step e).

8. The method according to claim 1, wherein a position of the first strip and/or the at least one second strip is fixed in the second direction by means of a retaining device or the first strip and/or the at least one second strip is/are affixed to the intermediate plate.

9. The method according to claim 1, wherein the intermediate plate is deformed upon at least one execution of step f) and after step f) is executed, a thickness of the material of the workpiece is greater at a position arranged between the first strip and at least one of the at least one second strips than at a position at which the first strip overlaps the workpiece along the first direction and/or is greater than at a position at which the at least one second strip overlaps the workpiece along the first direction.

10. The method according to claim 1, wherein a tool with a device is provided in step b) which is configured to limit flowing movement of the material of the workpiece during step f) in a third direction running perpendicular to the first direction and perpendicular to the second direction in order to obtain a leaded plate of a predetermined length for a battery which has at least one projection.

11. The method according to claim 1, wherein step a) comprises an extruding of a leaded material in order to obtain a leaded workpiece formed as a leaded extrudate, the leaded extrudate being arranged between the lower die and the upper die in step c).

12. The method according to claim 1, wherein a particle size of the material of the leaded plate for the battery having at least one projection is in a range of from 10 μm to 40 μm.

13. The method according to claim 1, wherein at least once prior to the repeated execution of steps e) and f), another deformable intermediate plate is arranged between the workpiece and the upper die or the lower die in step d) than in the previously executed steps e) and f).

14. The method according to claim 1, wherein the at least one recess is completely filled with a portion of the material of the workpiece after a final repetition of steps e) and f) has been executed.

15. The method according to claim 1, wherein after a final repetition of steps e) and f) has been executed, a length and/or width of the workpiece machined by means of the method is shortened to a predetermined length and/or a predetermined width, particularly using a punch tool, in order to obtain a leaded plate of a predetermined length and/or predetermined width for a battery which has at least one projection.

16. The method according to claim 1, wherein a leaded workpiece is provided in step a) which has a profile with a thickness measured in the first direction which varies along the second direction in a cross section along a plane spanned by the first direction and the second direction.

17. The method according to claim 16, wherein a leaded workpiece with a profile is provided in step a), the thickness of which is greater in two areas arranged substantially symmetrically about a center of the leaded workpiece arranged with respect to the second direction than in other areas.

18. A method for producing a bipolar plate for a battery, particularly a bipolar battery, the method comprising:
providing a substrate having at least one opening,
providing a leaded plate having at least one projection produced by means of the method according to claim 1,
providing a further leaded plate having at least one projection produced by means the method according to claim 1 or providing a substantially planar leaded plate, and
arranging the leaded plate having the at least one projection on a main face of the substrate such that the at least one projection extends into the at least one opening of the substrate, arranging the further leaded plate having the at least one projection on another main face of the substrate such that the at least one projection extends into the at least one opening of the substrate, and establishing an electrically conductive connection between one end of the at least one projection between one end of the at least one projection of the leaded plate having the at least one projection and one end of the at least one projection of the further leaded plate having the at least one projection, wherein the end of the at least one projection of the leaded plate having the at least one projection and the end of the at least one projection of the further leaded plate having the at least one projection face each other, and applying a first active material onto a main face, which faces away from the substrate, of the further leaded plate having the at least one projection and applying a second active material onto a main face, which faces away from the substrate, of the leaded plate having the at least one projection, or
arranging the leaded plate having the at least one projection on a main face of the substrate such that the at least one projection extends through the at least one opening of the substrate, arranging the substantially planar leaded plate on another main face of the substrate, and establishing an electrically conductive connection between the end of the at least one projection of the leaded plate having the at least one projection facing the substantially planar leaded plate and the substantially planar leaded plate, applying a first active material onto a main face, which faces away from the substrate, of the substantially planar leaded plate and applying a second active material onto a main face, which faces away from the substrate, of the leaded plate having the at least one projection.

19. The method according to claim 18, further comprising
providing a frame, and
arranging the frame such that the frame laterally surrounds the substrate, the leaded plate having the at least one projection, the further leaded plate having the at least one projection or the substantially planar leaded plate, the first active material and the second active material in the finished bipolar plate such that the frame laterally limits a free space above exposed surfaces of the first and second active material.

20. The method according to claim 19, wherein:
providing the frame comprises providing a frame formed integrally with the substrate, or
providing the frame comprises providing a frame having an internal groove, and a lateral section of the substrate is inserted into the groove.

21. A method for producing a battery, particularly a bipolar battery, the method comprising:
stacking multiple bipolar plates produced by the method according to claim 18 atop one another such that the respective first active materials of the individual bipolar plates point in the same direction in order to form a stack of bipolar plates, wherein a respective electrolyte is arranged between a respective pair of adjacent bipolar plates such that the respective electrolyte is both in contact with the first active material of one bipolar plate of the pair of bipolar plates as well as in contact with the second active material of the other bipolar plate of the pair of bipolar plates, and
establishing an electrically conductive connection between the first active material arranged on the main face, which faces away from the stack of bipolar plates, of a first bipolar plate of the stack of bipolar plates and a first terminal post of the battery, as well as
establishing an electrically conductive connection between the second active material arranged on the main face, which faces away from the stack of bipolar plates, of a last bipolar plate of the stack of bipolar plates and a second terminal post of the battery.

22. A battery, in particular a bipolar battery, produced utilizing a method according to claim 21.
